(19) United States
(12) Patent Application Publication
(10) Pub. No.: US 2010/0030714 A1
(43) Pub. Date: Feb. 4, 2010

(54) METHOD AND SYSTEM TO IMPROVE AUTOMATED EMOTIONAL RECOGNITION

(76) Inventors: Gianmario Bollano, Torino (IT); Donato Ettorre, Torino (IT); Antonio Esiliato, Campo Calabro (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/449,298

(22) PCT Filed: Jan. 31, 2007
(86) PCT No.: PCT/EP2007/000816

§ 371 Date: Jul. 31, 2009

(51) Int. Cl. G06F 15/18; G06N 5/02

(52) U.S. Cl. 706/12; 706/54

(57) ABSTRACT

An automated emotional recognition system includes an emotional state classifier adapted to receive, during an operative phase, an input information stream with embedded information related to emotional states of a person, and to generate a succession of emotional state indications derived from the input information stream. The emotional recognition system further includes a post-processing function, configured to receive at least two emotional state indications of the succession and, for each of said at least two emotional state indications, determine a corresponding emotional state representation in an emotional state representation system. The post-processing function is further configured to combine the emotional state representations of the at least two emotional state indications to obtain an output emotional state indication.

### BACKGROUND OF THE INVENTION

1. Field of the Invention

The present invention generally relates to the field of automated emotional recognition, and particularly to an emotional recognition system providing reliable and accurate emotional recognition services.

2. Description of the Related Art

The emotional recognition is a particular application in the artificial intelligence field. One of the aims of emotional recognition is to improve the naturalness of the communication between man and machine and to enhance the efficiency of the communication means. Several researches have been developed on this theme, and the possible applications of emotional recognition are still being investigated in the present days.

Part of said researches have been directed to the definition of different methods adapted to represent and evaluate the emotions. In particular, researches in the psychology field have found that an useful manner for representing the emotions calls for using so-called emotional representation diagrams. As known to those skilled in the art, an emotional representation diagram allows to graphically represent certain quantities from which it is possible to deduce the emotions in some ways. For example, known emotional representation diagrams are those proposed by Whissel and Plutchik.

Emotional representation diagrams are also illustrated in R. Cowie et al., “Emotion Recognition in Human-Computer Interaction”, IEEE SIGNAL PROCESSING MAGAZINE JANUARY 2001, pp. 33-80, and in K. R. Scherer, “What are emotions? And how can they be measured?”, Social Science Information, 2005, SAGE Publications, Vol. 44(4), pp. 695-729.

However, it has to be noted that the passage from a particular emotional representation diagram to a different one may produce significant alterations in the represented emotions. This is due to the fact that the emotions are not represented in a uniform way.

This drawback renders the use of said emotional representation diagrams for performing automated emotional recognitions really disadvantageous. Indeed, the automated emotional recognition is usually carried out by emotional state classifiers, that are adapted to associate to each particular emotion a corresponding state. One fundamental aspect of said approach consists in that each state defined by the emotional state classifier is independent from each other. However, as previously mentioned, the graphical representations of the emotions given by the emotional representation diagrams imply that among the states corresponding to different emotions there are smooth transitions and different degrees of alikeness.

On the other hand, an automated emotional recognition system that makes use of emotional classifiers only, without the possibility of representing the emotions through emotional representation diagrams, can not benefit of all the advantages given by graphical representation of the emotions.

### SUMMARY OF THE INVENTION

In view of the above, the Applicant has tackled the problem of improving the efficiency of known automated emotional recognition systems.

According to an aspect of the present invention, an automated emotional recognition system as set forth in the appended claim 1 is provided. The emotional recognition system comprises an emotional state classifier adapted to receive, during an operative phase, an input information stream with embedded information related to emotional states of a person, and to generate a succession of emotional state indications derived from said input information stream. The emotional recognition system further comprises a post-processing function, configured to receive at least two emotional state indications of said succession and, for each of said at least two emotional state indications, determine a corresponding emotional state representation in an emotional state representation system. The post-processing function is further configured to combine the emotional state representations of said at least two emotional state indications to obtain an output emotional state indication.

According to another aspect of the invention, a corresponding method for the automatic emotional recognition of a person as set forth in the appended claim 14 is provided.

### BRIEF DESCRIPTION OF THE DRAWINGS

The features and advantages of the present invention will be best understood by reading the following detailed description of some embodiments thereof, given merely by way of non-limitative example, that will be conducted making reference to the accompanying drawings, wherein:

FIG. 1 schematically shows, in terms of functional blocks, an emotional recognition system according to an embodiment of the present invention.

FIG. 2 illustrates a flow chart schematically showing the interactions of an emotional classifier block with the emotional recognition optimizer block of the emotional recognition system of FIG. 1, according to an embodiment of the present invention.

FIG. 3 schematically illustrates, in terms of functional blocks, the main functional components of the emotional recognition system of FIG. 1 for implementing a post-training directed to optimize system parameters, according to an embodiment of the present invention.

FIG. 4 schematically illustrates, in terms of functional blocks, the main functional components of the emotional recognition system of FIG. 1 for implementing a post-training directed to optimize emotional diagram configuration data, according to an embodiment of the present invention.

FIG. 5 illustrates an exemplary Whissel representation diagram.

FIGS. 6-8 illustrate Whissel representation diagrams that represent emotional states used by the emotional recognition system during the operation, according to an exemplary embodiment of the present invention.

### DETAILED DESCRIPTION OF THE PREFERRED EMBODIMENTS

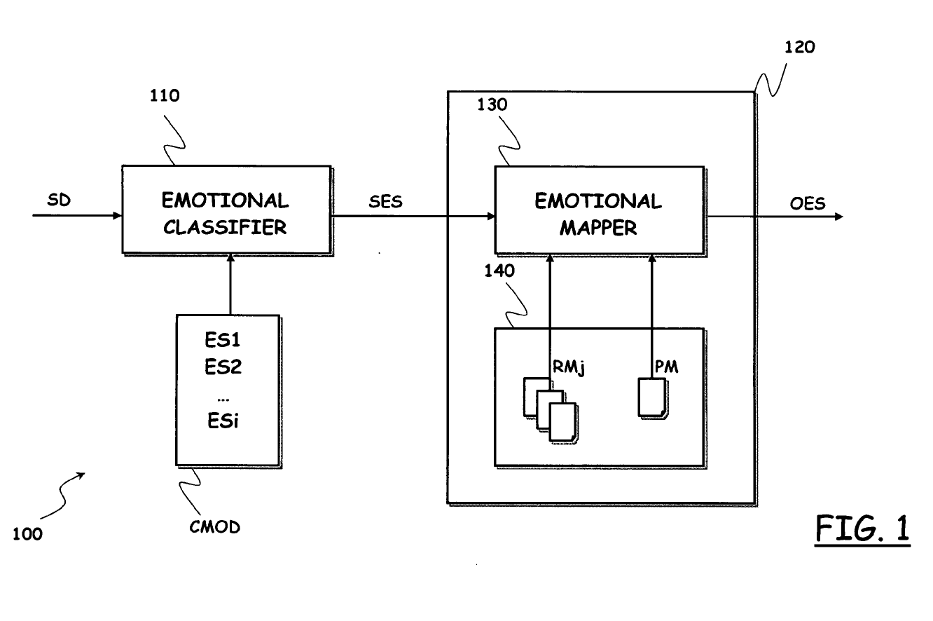

With reference to the drawings, FIG. 1 schematically shows, in terms of functional blocks, the main functional components of an automated emotional recognition system 100 according to an embodiment of the present invention, and, in terms of arrows, the data such functional components receive and provide from/to each other.

The emotional recognition system 100 includes an automated emotional state classifier block 110 coupled to an emotional recognition optimizer block 120.

The emotional state classifier block 110 is adapted to receive an information stream SD with embedded information related to emotional states of a person—for example speech data derived from an audio signal generated by transducing a portion (sp in the following) of a speech—for recognizing an emotional state indication SES indicative of the speaker's emotions. For the sake of simplicity, in the following of the present description it is assumed that the information stream SD is represented by speech data, though the invention is not limited to the employment of speech only. Indeed, the emotional recognition system 100 may employ data of different types, even not related to voice, such as images, for performing automatic emotion recognition. The emotional state classifier block 110 may be for example a state classifier, adapted to detect an emotional state among a plurality of emotional states ESi (i=1 to p) that have been classified according to associated emotions. Without entering into details not relevant to the understanding of the present invention, each emotional state ESi is univocally associated with a particular emotion; in the classification it performs, the emotional state classifier block 110 treats the different emotional states ESi to be independent (uncorrelated) from each other. In operation, the emotional state classifier block 110 makes use of a classification model CMOD that has been previously trained using a training database (not shown), for example a vocal database including a plurality of recorded speeches having a predetermined emotional content. In particular, without entering into details known to those skilled in the art, the classification model CMOD provides classification data and rules adapted to reproduce the relationships that have been established (during the model training) between the elements of the training database and corresponding emotional states ESi.

As will be described in detail in the following of the present description, the emotional recognition optimizer block 120 is responsible of processing and interpreting data denoting the emotional state indication SES, generated by the emotional state classifier block 110, for improving the accuracy and the reliability of the emotional recognition operation performed by the emotional recognition system 100. Moreover, as will be made apparent in the following of the present invention, the emotional recognition optimizer block 120 allows personalizing the emotional recognition function so as to conform to different possible contexts/scenarios of use of the emotional recognition system 100.

The emotional recognition optimizer block 120 includes an emotional mapping block 130 adapted to process the emotional state indication SES, provided by the emotional state classifier block 110, for deriving therefrom a corresponding output emotional state indication OES that represents an indication of the emotional state of the speaker that is regarded as more suitable to the use in the contexuscenario considered compared to that determined by the emotional state classifier block 110. More particularly, as will be described in detail in the following of the present description, the emotional recognition optimizer block 120 is adapted to map the emotional state indication SES selected by the emotional state classifier block 110 onto a selected emotional representation diagram, and then to use said selected emotional representation diagram as a dominium for performing a new classification of the emotional state indication SES.

According to an embodiment of the present invention, the emotional mapping block 130 is coupled to a configuration block 140, which is adapted to store configuration data that are provided to the emotional mapping block 130 for the configuration thereof depending on the different possible contexts/scenarios of use of the emotional recognition system 100. According to an embodiment of the present invention, the configuration block 140 is adapted to store a plurality of emotional diagram configuration datasets RMj (j=1 to q), each dataset defining coordinates in a corresponding emotional representation diagram R that can be used by the emotional mapping block 130 for performing mapping operations on the emotional state indication SES. More particularly, according to an embodiment of the present invention, each emotional representation diagram R allows to geometrically represent the emotional states ESi in a diagrammatic way that makes use of a whichever n-dimensional space, and in which to each emotion a distinct set of n values is univocally associated. Moreover, the configuration block 140 is adapted to store additional configuration data specifying additional information directed to better characterize the operations that the emotional mapping block 130 has to perform. Said additional configuration data are globally referred to as system parameters PM.

The operation of the emotional recognition system 100 will be now described.

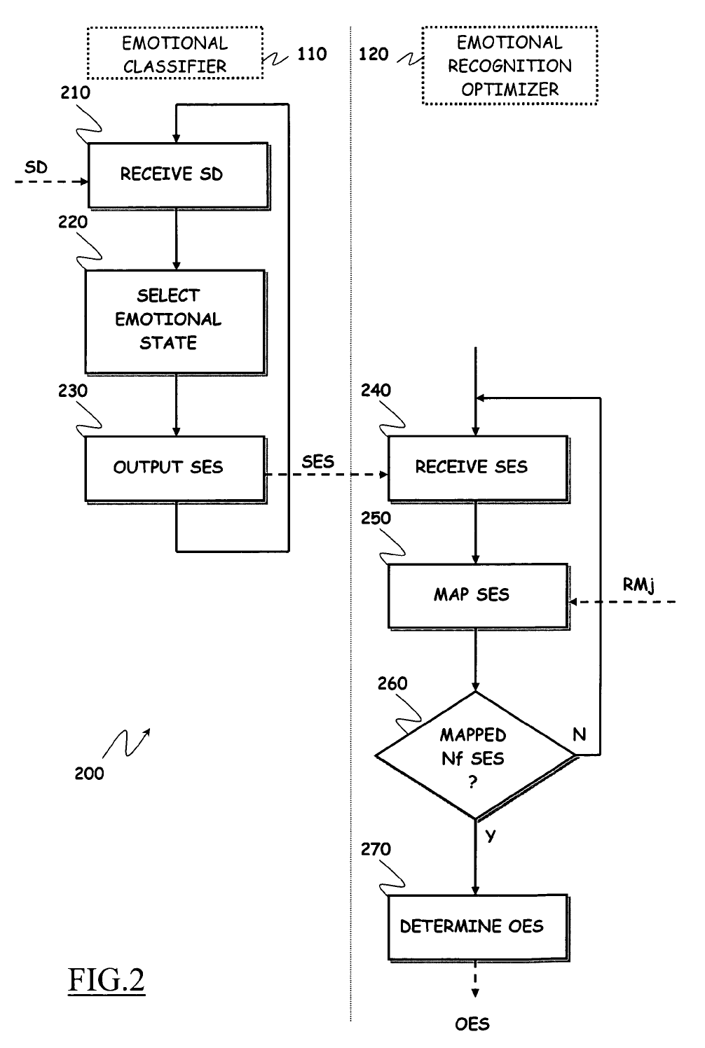

FIG. 2 illustrates a flow chart 200 schematically showing the interactions of the emotional state classifier block 110 with the emotional recognition optimizer block 120 when operating, according to an embodiment of the present invention.

Firstly, every time frame t, having for example a time duration of two seconds, the emotional classifier block 110 receives a set of speech data SD (block 210), corresponding to a particular portion sp of a speech to be analyzed for emotional recognition.

For each time frame t during which a set of speech data SD is provided thereto, the emotional state classifier block 110 selects which emotional state ESi among the classified emotional states ESi is the most representative of the emotion experienced by the speaker (block 220), and accordingly provides to the emotional recognition optimizer block 120 data denoting the emotional state indication SES (block 230). According to an embodiment of the present invention, the emotional recognition optimizer block 120 is adapted to determine the output emotional state indication OES based on the processing of a number Nf of emotional state indications SES provided by the emotional state classifier block 110 in Nf consecutive time frames t. According to an embodiment of the present invention, the number Nf of emotional state indications SES to be processed by the emotional recognition optimizer block 120, i.e. the time window implemented by the emotional recognition optimizer block 120 is one of the system parameters PM that can be used for configuring the emotional recognition system 100.

Therefore, the emotional recognition optimizer block 120 receives the emotional state indication SES from the emotional state classifier block 110 (block 240), and starts to perform mapping operations on the emotional state indication SES using a selected emotional representation diagram R defined by a selected emotional diagram configuration dataset RMj (block 250).

More particularly, the emotional state indication SES is provided to the emotional mapping block 130, wherein it is subjected to a transformation according to a univocal relationship, which associates to the emotional state indication SES an n-dimensional coordinate in the selected emotional representation diagram R. For example, if the selected emotional representation diagram R is a bi-dimensional Cartesian space, the emotional state indication SES will be associated with a pair of Cartesian coordinates (x,y).

Then, the emotional recognition optimizer block 120 checks whether the emotional mapping block 130 has already mapped a number Nf of emotional state indications SES, or still has to map further emotional state indications SES. In other words, the emotional recognition optimizer block 120 waits for receiving a number Nf of successive emotional states

In case the number of emotional state indications SES that have been previously mapped by the emotional mapping block 130 is less than Nf, the emotional recognition optimizer block 120 receive from the emotional state classifier block 110 a further emotional state indication SES (decisional block 260, exit branch N).

When the number of emotional state indications SES that have been already received and mapped is equal to Nf (decisional block 260, exit branch Y), the emotional mapping block 130 processes all the results of the previous Nf mapping, for obtaining the output emotional state indication OES (block 270). In particular, the output emotional state indication OES determined by the emotional mapping block 130 by properly processing the Nf consecutive emotional states corresponds to a new n-dimensional coordinate in the selected emotional representation diagram R which globally represents an optimized version of the set of Nf emotional state indications SES. The n-dimensional coordinate of the output emotional state indication OES is obtained through a combination of the n-dimensional coordinates of the Nf emotional state indications SES.

Different kind of combinations of the n-dimensional coordinates of the Nf selected emotional state indications SES are possible, the specific type of combination not being limitative of the present invention.

In order to determine the n-dimensional coordinate of the output emotional state indication OES, the emotional mapping block 130 may for example implement an algorithm that strictly depend on the emotional representation diagram R that has been selected. For example, if the selected emotional representation diagram R is an n-dimensional Cartesian space, wherein each emotional state is defined by an n-dimensional coordinate, the n-dimensional coordinate of the output emotional state indication OES may be obtained by calculating an algorithm that makes use of the ‘minimal distance’ from the Nf emotional states.

Although the emotional recognition system 100 described in connection with the FIGS. 1 and 2 is adapted to receive speech data SD for recognizing the emotions of a speaker from which the speech data SD have been originated, similar considerations apply in case the emotional state classifier block 110 receives data adapted to identify the emotional state of a person, which data having been generated trough the analysis of his/her posture, facial expression, and the like.

As previously mentioned, the emotional recognition system 100 can be configured depending on different possible contexts of use. This can be achieved by properly setting the configuration data stored in the configuration block 140, i.e., the emotional diagram configuration datasets RMj and the system parameters PM. For example, the emotional recognition system 100 may be configured by using a particular emotional representation diagram R instead of another, or by changing the number Nf of emotional state indications SES to be combined for obtaining the output emotional state indication OES.

The emotional diagram configuration datasets RMj and the system parameters PM may in particular be optimized depending on a particular emotional perception that a particular user of the emotional recognition system 100 may wish to recognize, or depending on the reduction of the overall error that can be measured on a post-training database. This can be achieved by detecting errors done by the emotional recognition optimizer block 120, for example the number of emotions that have been incorrectly recognized, and comparing the output emotional state indication OES with desired emotional states (e.g. according to the recognition of one or more users), using different emotional diagram configuration datasets RMj and system parameters PM during the process.

In order to optimize the emotional diagram configuration datasets RMj and the system parameters PM, the emotional recognition optimizer block 120 is subjected to a “post-training” phase. The post-training phase is intended to be performed after the training of the classification model CMOD used in operation by the emotional state classifier block 110. In particular, as will be described in the following, in order to be effective, the post-training phase makes use of a post-training database PDB that has in advance been classified as suitable for the context/scenario of use considered.

The post-training database PDB may for example coincide with the training database that has been previously used by the emotional state classifier block 110, but it is important to underline that the post-training database PDB is independent from it, since the post-training phase does not have any influence on the training of the emotional state classifier block 110.

The post-training phase is directed to optimize both the system parameters PM and the emotional diagram configuration datasets RMj in order to reduce the occurrence of wrong emotional recognitions. More in particular, the post-training phase may be designed in such a way as to allow achieving two distinct optimizations: one directed to optimize of the system parameters PM, and another directed to optimize the emotional diagram configuration datasets RMj.

An example of a post-training phase for optimizing the system parameters PM—for example, the number Nf of emotional state indications SES to be combined for obtaining the output emotional state indication OES—will be now described in detail.

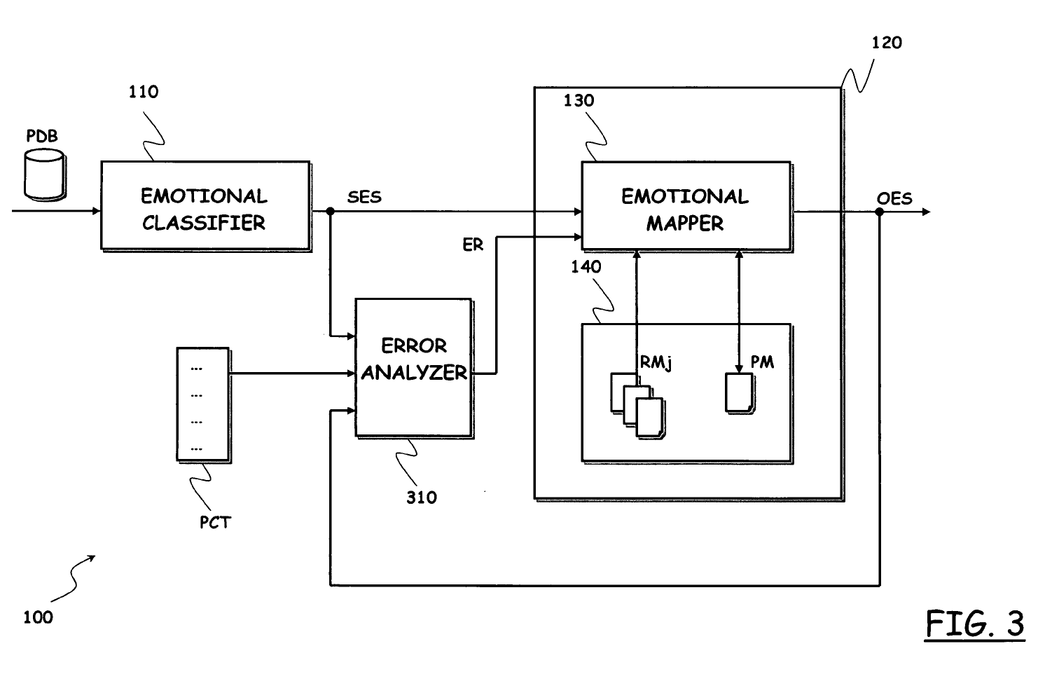

FIG. 3 schematically illustrates, in terms of functional blocks, the main functional components of the emotional recognition system 100 for implementing a post-training directed to optimize the system parameters PM, according to an embodiment of the present invention. The elements corresponding to those shown in the FIG. 1 are denoted with the same references, and their explanation is omitted for the sake of brevity.

According to the embodiment of the present invention illustrated in FIG. 3, the speech data SD that is fed to the emotional state classifier block 110 is included in the post-training database PDB. In this way, during the post-training phase, the selected emotional state indications SES output by the emotional state classifier block 110 are generated depending on the elements of the post-training database PDB, instead of being generated in response to a generic speech data that has not been previously classified according to the perception of one or more users.

In order to perform the post-training phase for optimizing the system parameters PM, the emotional recognition system 100 further includes an error analyzer block 310. The error analyzer block 310 is adapted to receive the emotional state indications SES selected by and output by the emotional state classifier block 110, the output emotional state indication OES calculated and output by the emotional recognition optimizer block 120 and a post-training classification table PCT, which establishes a reference emotional state, determined by one of more users in a previous phase, for each of the elements of the post-training database PDB. Depending on these inputs, the error analyzer block 310 is adapted to determine error data ER that are indicative of the inaccuracy of the output emotional state indication OES. This can be achieved by comparing the reference emotional state defined in the post-training classification table PCT with the emotional state indications SES and the output emotional state indication OES. The error data ER generated by the error analyzer block 310 provide useful information on the effective improvement that can be achieved using the emotional recognition optimizer block 120.

The operation of the emotional recognition system 100 during the post-training directed to optimize the system parameters PM, will be now described according to an embodiment of the present invention.

The configuration data stored in the configuration block 140 have an initial value. For example, the values of the system parameters PM determine the desired number Nf of emotional state indications SES to be processed by the emotional mapping block 130 for obtaining the output emotional state indication OES.

Depending on which element of the post-training database PDB receives, the emotional state classifier block 110 determines a corresponding emotional state indications SES.

The emotional mapping block 130 receives from the emotional state classifier block 110 a number Nf of successive emotional state indications SES, and accordingly determines an output emotional state indication OES, using a particular emotional representation diagram R, as defined by the emotional diagram configuration datasets RMj (which are assumed to be kept fixed).

Data indicative of the output emotional state indication OES are then provided to the error analyzer block 310, which accordingly generates the error data set ER.

The emotional mapping block 130 receives from the error analyzer block 310 the error data ER, which are indicative of the inaccuracy of the calculated output emotional state indication OES. Depending on the error data ER, the emotional mapping block 130 determines whether the system parameters PM used for generating the output emotional state indication OES needs to be updated or not, and, in the affirmative case, produces updated, optimized system parameters PM intended to replace the initial system parameters. The emotional mapping block 130 can use a wide set of known algorithms for performing the selection of an optimal value for the system parameters. For example, simple iterative method, such as binary search among a maximum and minimum value, or analytic method, such as genetic algorithm or forward selection, can be used to implement the search of a sub-optimal set of system parameters. Said optimization is independent from the emotional state classifier block 110 and makes use of relatively low processing resources compared to those normally employed for training the classification model CMOD. This aspect is very relevant because allows to obtain the output emotional state indication OES without the need of performing complex operations directed to optimize the behavior of the emotional state classifier block 110. The emotional mapping block 130 can use the error data ER to evaluate the effect of different sets of system parameters PM, selecting, after few iterations, an optimal or sub-optimal sets thereof capable of improving the emotional recognition in the scenario of use of the emotional recognition system 100 represented by the post-training database PDB.

Updating of the system parameters PM may for example involve varying the number Nf of emotional state indications SES to be processed.

The values of the updated, optimized system parameters PM may be stored into the configuration block 140.

The post-training operations may be repeated using the updated system parameters PM, for example, using a different number Nf of emotional state indications SES to be processed by the emotional mapping block 130. In this way, the emotional mapping block 130 generates a new output emotional state indication OES to be provided to the error analyzer block 310.

In case the emotional mapping block 130, based on the error data ER, determines that the system parameters PM used for generating the output emotional state indication OES do not need to be updated, the current system parameters PM are considered to be already optimized.

The post-training database PDB and the post-training classification table PCT may be common for all users, or they may be selected by the user. This allows customizing the post-training operations, and consequently the system parameters PM. In this way, the emotional recognition system 100 can be trained for recognizing emotional states according to the emotional perceptions of particular users.

The post-training directed to optimize the emotional diagram configuration datasets RMj will be now described in detail.

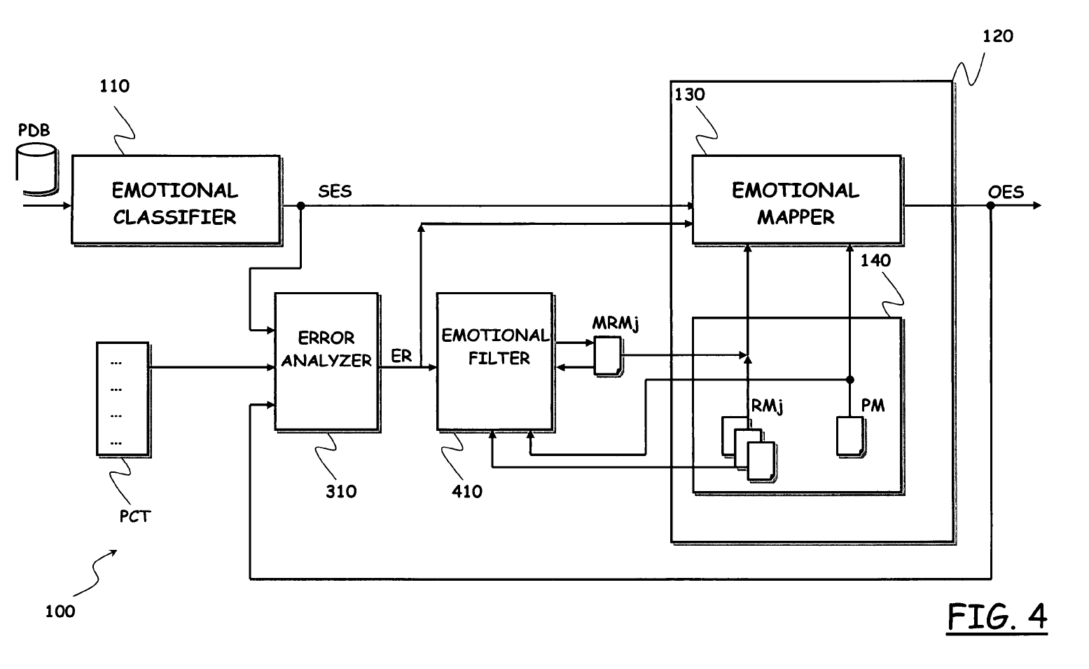

FIG. 4 schematically illustrates, in terms of functional blocks, the main functional components employed by the emotional recognition system 100 during the post-training directed to optimize the emotional diagram configuration datasets RMj, according to an embodiment of the present invention. The elements corresponding to those shown in the FIG. 3 are denoted with the same references, and their explanation is omitted for the sake of brevity.

Even in this case, the emotional state classifier block 110 is fed with the elements included in the post-training database PDB, and a corresponding post-training classification table PCT is fed to an input of the error analyzer block 310.

In order to perform the post-training phase directed to optimize the emotional diagram configuration datasets RMj, the emotional recognition system 100 further includes an emotional filter block 410 connected between the error analyzer block 310 and the emotional mapping block 130. The emotional filter block 410 is adapted to receive the error data ER provided by the error analyzer block 310 and the system parameters PM from the configuration block 140. Moreover, the emotional filter block 410 is adapted to receive the emotional diagram configuration dataset RMj corresponding to a particular emotional representation diagram R to be optimized. Depending on said inputs, the emotional filter block 410 is adapted to modify the emotional diagram configuration dataset RMj for generating corresponding modified emotional diagram configuration dataset MRMj that define a modified version MR of the emotional representation diagram R.

The operation of the emotional recognition system 100 during the post-training directed to optimize the emotional diagram configuration datasets RMj are similar to those previously described in reference to FIG. 3.

In particular, the post-training phase starts with the emotional diagram configuration dataset RMj stored in the configuration block 140, which defines a particular emotional representation diagram R to be optimized. The system parameters PM may either be set according to default values, or alternatively, they may be the result of a post-training phase that has been previously performed.

Depending on which element of the post-training database PDB it receives, the emotional state classifier block 110 determines a corresponding emotional state indication SES.

The emotional mapping block 130 receives from the emotional state classifier block 110 data denoting a number Nf of emotional state indications SES, and accordingly determines an output emotional state indication OES using the emotional representation diagram R to be optimized, defined by the emotional diagram configuration dataset RMj presently stored in the configuration block 140.

Data denoting the output emotional state indication OES are then provided to the error analyzer block 310, which accordingly generates the error data ER.

Based on the error data ER received from the error analyzer block 310 and on the emotional diagram configuration dataset RMj, the emotional filter block 410 generates corresponding modified emotional diagram configuration data MRMj defining a modified version MR of the emotional representation diagram R. According to an embodiment of the present invention, the emotional filter block 410 may modify the emotional representation diagram R using two different approaches, depending on the degree of optimizaton desired.

More particularly, the emotional filter block 410 may modify the n-dimensional coordinates that identify the emotional states in the emotional representation diagram R. This approach is particularly efficient in case the system is to be optimized for a high number of different scenarios of use, and when the emotional recognition system 100 is shared among a large number of users, since it acts on the emotional representation diagram R only, without the need of further trainings of the emotional classifier 110.

Alternatively, the emotional filter block 410 may vary the number of emotional states used by the emotional mapping block 130 for determining the output emotional state indication OES. This second approach allows in particular reducing the number of emotions that can be recognized by the emotional recognition system 100 without the need of training a new emotional state classifier block 110.

Once the emotional filter block 410 has obtained the modified emotional representation diagram MR, the corresponding modified diagram configuration dataset MRMj is provided to the emotional mapping block 130.

Then, the emotional mapping block 130 redetermines the output emotional state indication OES employing the modified emotional representation diagram MR defined by the modified emotional diagram configuration dataset MRMj.

This process is repeated until the modified emotional diagram configuration datasets MRMj are reputed to define a corresponding modified emotional representation diagram MR sufficiently optimized. In order to establish whether an emotional representation diagram can be regarded as optimized or not, the emotional mapping block 130 may define and exploit a cost function which depends on the error data ER provided by the error analyzer block 310 and on the emotional representation diagram used. An optimized modified emotional representation diagram MR will correspond to the emotional representation diagram that minimizes the emotional recognition error according to said cost function.

The modified emotional diagram configuration datasets MRMj may be used for updating the emotional diagram configuration datasets RMj stored into the configuration block 140.

Even in this case, the post-training database PDB and the post-training classification table PCT may be common for all users, or they may be selected by the user. For example, different users may decide to fill the post-training database PDB with different speech data SD. Moreover, since each user may perceive the emotions in a different way, different post-training classification tables PCT may be selected for performing the post-training operations with a same post-training database PDB. This allows customizing the post-training operations, and consequently the emotional diagram configuration data RM. In this way, the emotional recognition system 100 can be trained for recognizing emotional states according to the emotional perceptions of particular users.

The two post-training phases previously described in reference to the FIGS. 3 and 4 are preferably independent from each other, and they may be performed in different time sequence. However, it is preferable to perform the post-training phase directed to optimize the system parameters PM first, since, even if the operations performed by the emotional recognition system 100 during said post-training phase may make use of relatively low processing resources, the post-training directed to optimize the system parameters PM allows optimizing the emotional recognition system with a high flexibility.

Thanks to the peculiarity of the emotional recognition system 100 proposed, the automated emotional recognition process carried out by the emotional state classifier block 110 can be optimized by the emotional recognition optimizer block 120 with techniques that are independent both from the classification models used for the emotional recognition and from the emotional representation diagrams used for representing them.

The advantages of the proposed emotional recognition system 100 are several, since the emotional recognition errors that can be carried out by the emotional state classifier block 110 can be reduced without having to modify the classification model used by the emotional state classifier block 110. This reduction of emotional recognition errors is accomplished by the emotional recognition optimizer block 120, which may take into account both the indications of one or more users (for customizing the interpretation of the emotions) and the results obtained from statistical systems independent from the classification model used by the emotional state classifier block 110. Moreover, the optimization of the emotional recognition process carried out by the emotional state classifier block 110 can be executed independently from which emotional representation diagram has been chosen for the representation of the emotional states.

In the following of the present description, an example of how the emotional recognition system 100 according to an embodiment of the present invention may be practically employed will be described.

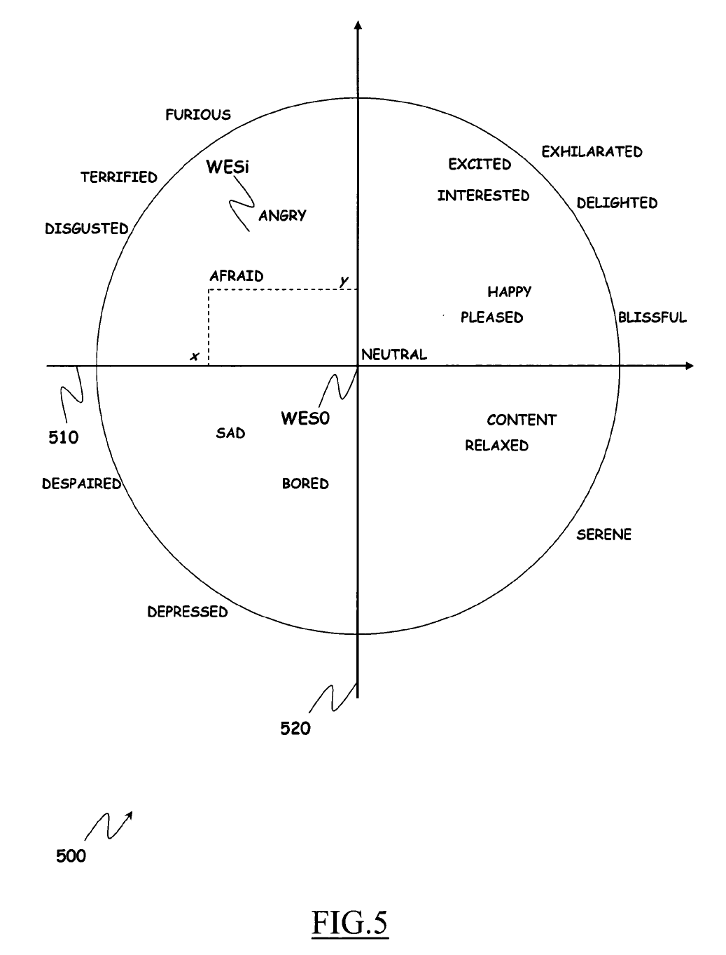

According to this example, the emotional representation diagrams R employed by the emotional recognition system 100 make use of the Whissel representation 500 illustrated in FIG. 5. As known to those skilled in the art, the Whissel representation 500—also known as “Whissel's wheel”—defines the emotions as points of a bi-dimensional space defined by two orthogonal axis; a horizontal axis 510, known as “evaluation” axis, that is related to the valence of the perception (positive or negative), and a vertical axis 520, known as “activation” axis, related generally to the energy of the speech signal, that specifies the excitation and emphasis levels of the emotions.

The Whissel representation 500 defines a plurality of p emotional states WESi (i=0 to p−1), each one identifiable by a pair of coordinates (x,y) on the axes 510, 520. In particular, the coordinate x refers to the evaluation axis 510, and the coordinate y refers to the activation axis 520. The point of coordinates (x=0,y=0), i.e., the origin of the axes 510, 520, correspond to a “neutral” emotional state WES0.

The collection of the coordinates (x, y) of all the p emotional states WES1 univocally defines a corresponding emotional representation diagram R. According to an embodiment of the present invention, data defining said collection of the coordinates (x,y) are included in the emotional diagram configuration dataset RMj defining the emotional representation diagram R.

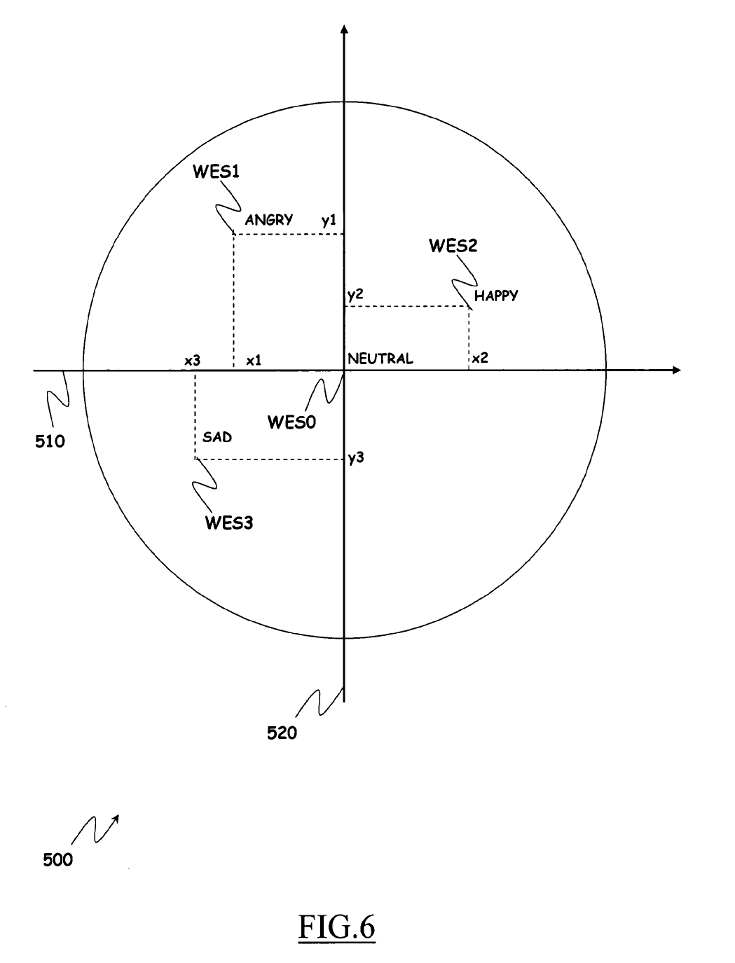

In order to simplify the description of the example herein considered, reference will now be made to a Whissel emotional representation diagram R′ including four emotional states WESi only, as shown in FIG. 6:

neutral (corresponding to the emotional state WES0 having coordinates (x=x0, y=y0));

angry (corresponding to the emotional state WES1 having coordinates (x=x1, y=y1));

happy (corresponding to the emotional state WES2 having coordinates (x=x2, y=y2));

sad (corresponding to the emotional state WES3 having coordinates (x=x3, y=y3)).

The data defining the coordinates (x, y) of said four emotional states WESi are included in a corresponding emotional diagram configuration dataset RMj′.

Moreover, according to this example, the system parameters PM are set in such a way that the number Nf of emotional state indications SES to be combined by the emotional mapping block 130 for obtaining the output emotional state indication OES is equal to three (i.e., the system works on a time window of three consecutive emotional states).

As previously described, according to an embodiment of the present invention, during the operation of the emotional recognition system 100 the output emotional state indication OES is determined by the emotional mapping block 130 in a two-step process. Firstly, the emotional mapping block 130 maps the Nf emotional state indications SES received from the emotional state classifier block 110 using a particular dimensional emotional representation diagram R—in this example, the Whissel bi-dimensional emotional representation diagram R′. Then, once the Nf emotional state indications SES have been mapped, the output emotional state indication OES is obtained trough a combination of the coordinates of the Nf emotional state indications SES—in this example, a combination of the coordinates (x, y). The second step may be performed by the emotional mapping block 130 depending on different algorithms, for example chosen by the designer of the emotional recognition system 100.

More in particular, according to the example at issue, the coordinates (x, y) of the Nf emotional state indications SES that have been mapped are firstly combined for obtaining a pair of combined coordinates (xc, yc) which corresponds to a weighted average of the Nf coordinates (x, y) of the emotional state indications SES. Said weighted average is calculated by taking into account the number ni of occurrence of each emotional state WESi of the Whissel emotional representation diagram R′ among the Nf emotional state indications SES. The combined coordinates (xc, yc) thus obtained are the following:

$${x}_{c} = \frac{n 0 \cdot x 0 + n 1 \cdot x 1 + n 2 \cdot x 2 + n 3 \cdot x 3}{Nf} ;$$

$${y}_{c} = \frac{n 0 \cdot y 0 + n 1 \cdot y 1 + n 2 \cdot y 2 + n 3 \cdot y 3}{Nf} .$$

If, for example, the Nf emotional state indications SES provided to the emotional mapping block 130 by the emotional state classifier block 110 correspond to two angry emotional states WES1 and one neutral emotional state WES0, the combined coordinates (xc, yc) are the following:

$${x}_{c} = \frac{1 \cdot x 0 + 2 \cdot x 1}{3} ;$$

$${y}_{c} = \frac{1 \cdot y 0 + 2 \cdot y 1}{3} .$$

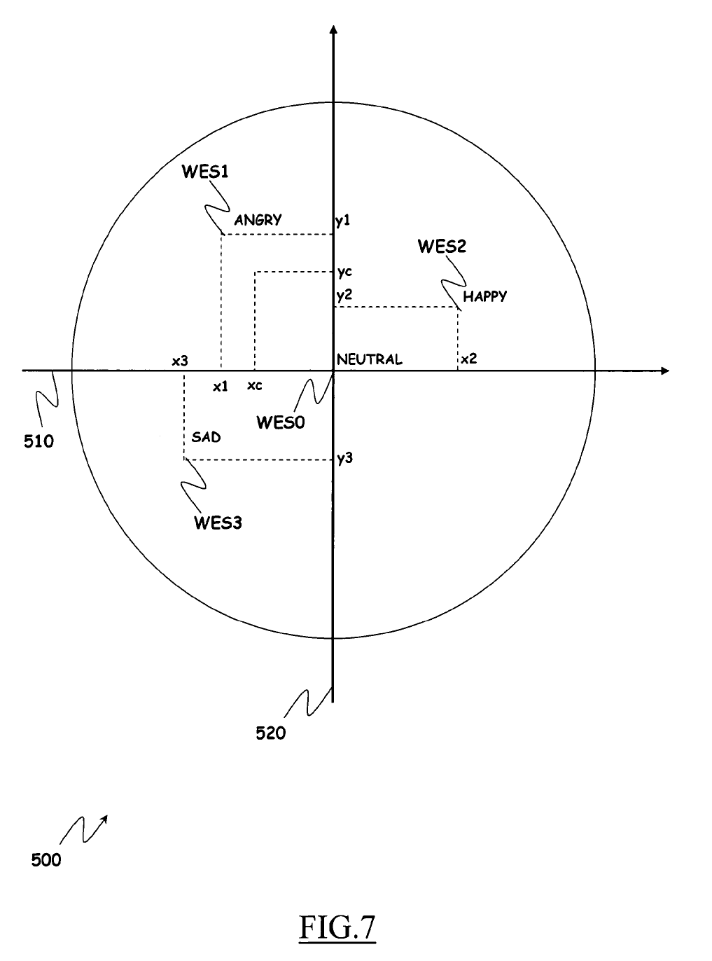

These combined coordinates (xc, yc) are depicted in FIG. 7 using the Whissel emotional representation diagram R′ 500.

This approach allows determining combined coordinates (xc, yc) that take into account the general emotional course of the speaker during the temporal window defined by the Nf emotional state indications SES generated by the emotional state classifier block 110.

Additionally, it is possible to weight the average using further indexes that indicate the accuracy of the emotional state classifier block 110.

Once the combined coordinates (xc, yc) have been obtained, the output emotional state indication OES may be determined in different ways.

For example, according to an embodiment of the present invention, the combined coordinates (xc, yc) may be directly used for defining the output emotional state indication OES. In this case, the output emotional state indication OES generally will not coincide with any one of the emotional states defined by the emotional representation diagram.

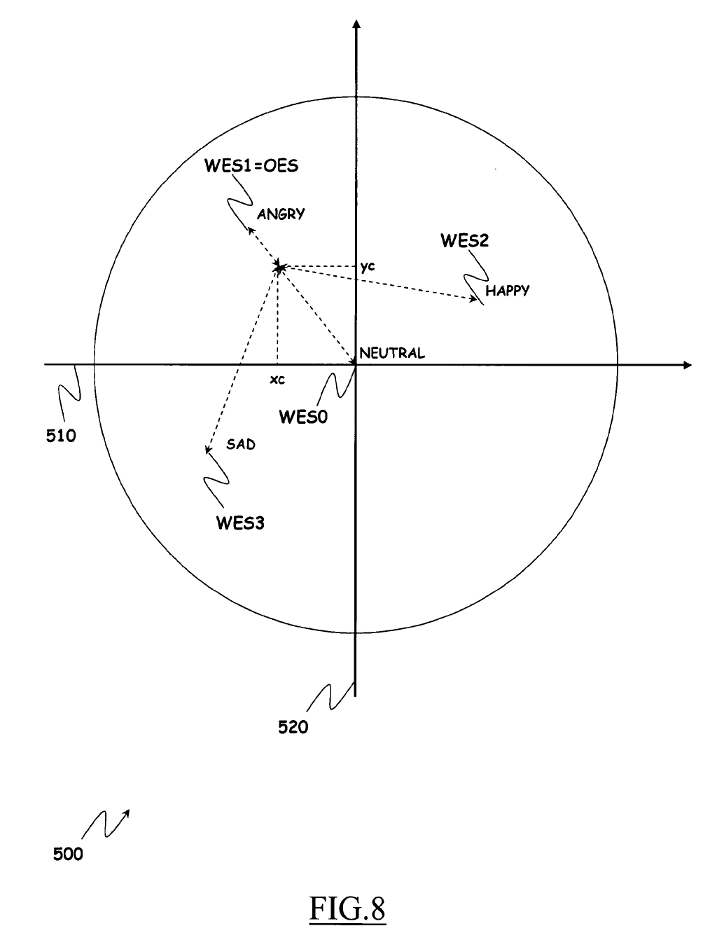

Alternatively, the emotional mapping block 130 may determine which emotional state among those defined by the emotional representation diagram is the “nearest” to the combined coordinates (xc, yc). For example, according to the example at issue, the emotional mapping block 130 calculates the emotional state WES1 having the coordinates (x=xi, y=yi), that is at the minimum distance from the emotional state defined by the combined coordinates (xc, yc). As can be shown in FIG. 8, in the example at issue, the output emotional state indication OES corresponding to the combination of two angry emotional states WES1 and one neutral happy emotional state WES0 coincide with the angry emotional state WES1

It is clear that when all the received Nf emotional state indications SES correspond to a same emotion, the resulting output emotional state indication OES will coincide to that emotional state indication SES.

As previously described, both the emotional diagram configuration datasets RMj and the system parameters PM may be optimized depending on a particular emotional perception that a particular user of the emotional recognition system 100 may desire to recognize, or depending on the reduction of the whole error that can be measured on a training database. For this purpose, the system recognition system 100 is subjected to the post-training.

Hereinafter, an example is presented of how the post-training phase directed to optimize the emotional diagram configuration dataset RMj that define the representation diagrams R can be performed by the emotional recognition system 100.

Even in this example, reference will be made to a representation diagram R following the Whissel representation 500 previously described. In order to simplify the description, it is supposed that by said representation diagram R only seven different emotional states WESi can be defined, and in particular those corresponding to “angry”, “bored”, “disgusted”, “afraid”, “blissful”, “sad” and “neutral” emotional states.

As previously mentioned, purpose of the post-training directed to optimize the emotional diagram configuration dalasets RMj consists in modifying the coordinates—in the selected emotional representation diagram R—of the emotional states in order to minimize the emotional recognition error, by using the error data ER generated by the error analyzer block 310.

According to an exemplary embodiment of the present invention, the emotional diagram configuration dataset RMj, and thus the corresponding emotional representation diagrams R, can be optimized by analyzing a “confusion matrix” that is associated to the analysis of the output emotional state indication OES generated by the emotional recognition optimizer block 120. Since, as previously explained, the output emotional state indication OES is obtained using an emotional representation diagram R defined by an emotional diagram configuration dataset RMj there exists a relation of dependency between the confusion matrix and the emotional diagram configuration dataset RMj. As known to those skilled in the art, a confusion matrix provides indications regarding the distribution of the recognition error for a determined sequence of emotional states. According to an embodiment of the present invention, the confusion matrix is generated by the error analyzer block 310 using the post-training database PDB and the post-training classification table PCT. Therefore, the confusion matrix provides indications regarding the recognition errors of the output emotional state indication OES.

In a different embodiment of the present invention, a second confusion matrix may be derived from an emotional state indication SES for giving initial information even when the emotional diagram configuration dataset RMj has not yet been selected, or when the output emotional state indication OES has not yet been calculated by the emotional mapping block 130.

An example of a confusion matrix obtained using the Whissel representation diagram R considered herein may be the following:

| | Angry | bored | disgusted | Afraid | blissful | sad | neutral |
|---|---|---|---|---|---|---|---|
| angry | 80.31 | 0.79 | 3.15 | 3.94 | 8.66 | 0 | 3.15 |
| bored | 0 | 66.67 | 6.17 | 2.47 | 0 | 7.41 | 17.28 |
| disgusted | 3.15 | 17.39 | 52.17 | 4.35 | 4.35 | 10.87 | 2.17 |
| afraid | 10.24 | 4.35 | 5.80 | 40.58 | 4.35 | 10.14 | 15.94 |
| blissful | 18.11 | 0 | 4.23 | 5.63 | 52.11 | 0 | 5.63 |
| sad | 0 | 11.29 | 0 | 1.61 | 0 | 82.26 | 4.85 |
| neutral | 2.36 | 17.71 | 5.06 | 7.59 | 0 | 2.53 | 63.29 |

For the purpose of optimizing the emotional diagram configuration dataset RMj, the confusion matrix is generated using the post-training database PDB and the post-training classification table PCT. Each row of the confusion matrix corresponds to an emotional state WESi that has to be recognized according to the indication provided by the post-training classification table PCT, while each column of the confusion matrix corresponds to the selection of a particular output emotional state indication OES. According to an embodiment of the present invention, the confusion matrix is generated by the error analyzer block 310 and is included in the error data ER. Optionally, the second confusion matrix can be generated using the emotional state indication SES carried out by the emotional state classifier block 110. The generic element of the confusion matrix provides the percentage of possibilities that the emotional state classifier block 110 selects the emotional state corresponding to that labeled in the corresponding column, given that the real emotional state is equal to that labeled in the corresponding row. The sums of the percentages provided by all the elements of a row corresponds to a percentage of 100%. It is clear that the values provided by the elements of the main matrix diagonal are the percentage of possibilities corresponding to correct selection performed by the emotional state classifier block 110.

In this context, the confusion matrix provides very useful information regarding the accuracy of the emotional recognition system 100. Indeed, the higher the accuracy provided by the emotional recognition system 100, the higher the values of the percentages provided by the elements of the main diagonal. By observing how said percentages are distributed among the elements of a row, it is possible to quantify the inaccuracy of the emotional recognition system 100. This information can be expediently used for modifying the emotional diagram configuration datasets RMj in such a way as to find the emotional representation diagram R adapted to minimize the emotional recognition error of the system. Thanks to this possibility, it is also possible to pass from a standard way of representing the emotional states to a personalized one by changing the post-training classification table PCT for satisfying the subjective emotional perception of one or more users.

A practical use of the confusion matrix for the optimization of the emotional diagram configuration datasets RMj provides for the definition of an error function E(i) for each emotional state WESi, that provides a quantification of the error in the recognition of the corresponding emotional state WESi.

For this purpose, the elements of each row of the confusion matrix are normalized, in such a way that the element corresponding to a generic i-th row and to the generic j-th column provides the probability p(i,j) that, given an emotional state WES1, said emotional state is recognized by the emotional recognition system 100 as the emotional state WESj. In case i=j, the corresponding probability p(i,j) represents the probability of a correct emotional recognition.

For each i-th row of the confusion matrix, it is:

$${\sum }_{j = 1}^{N} p ( i , j ) = 1 ,$$

wherein N is the number of different emotional states WESi provided by the selected emotional representation diagram R, and corresponds to both the number of rows and columns of the confusion matrix (in the example at issue, N is equal to 7).

Consequently, an optimal choice for defining the error function E(i) of the recognition of the emotional state WESi may be given by the sum of all the probabilities p(i,j) provided in the i-th row minus the probability p(i,i) of a correct emotional recognition of the emotional state WESi:

$$E ( i ) = {\sum }_{{j = 1}_{j \neq i}}^{N} p ( i , j ) = 1 - {p}_{ii} .$$

Said error functions E(i) may be combined to each other for defining a global error function GE that characterize the whole emotional recognition system 100.

For example, the global error function GE can be obtained by calculating the average of the error functions E(i) corresponding to all the N emotional states WESi that can be represented with the emotional representation diagram R:

$$GE = \frac{1}{N} {\sum }_{i = 1}^{N} E ( i ) .$$

The global error function GE depends on the confusion matrix (or other equivalent data) generated by the Error Analyzer block 310. As previously explained, the confusion matrix is dependent on the diagram configuration dataset RMj; therefore, the global error function GE can be used as an effective relation expressing recognition errors as a set of functions of the diagram configuration dataset RMj.

By changing the emotional representation diagram R (which can be achieved changing the emotional diagram configuration dataset RMj), and/or by changing the coordinates used in the selected emotional representation diagram R for representing the emotional states WESi, it is possible to vary the performance of the emotional recognition system 100, since the elements of the confusion matrix, and consequently, the corresponding error functions E(i), are accordingly varied.

Thus, an optimum emotional representation diagram R is that whose coordinates are capable of minimizing the above described global error function GE.

A wide set of known algorithms can be used to perform the selection of an optimal value for the diagram configuration dataset RM. For instance, methods such as genetic algorithms or forward selections can be used for implementing the search of the sub-optimal set of values for the diagram configuration dataset RMj. Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

1-28. (canceled)

29. An automated emotional recognition system, comprising:
an emotional state classifier capable of being adapted to receive, during an operative phase, an input information stream with embedded information related to emotional states of a person, and to generate a succession of emotional state indications derived from said input information stream;
a post-processing function, capable of being configured to:
receive at least two emotional state indications of said succession;
for each of said at least two emotional state indications, determine a corresponding emotional state representation in an emotional state representation system; and
combine the emotional state representations of said at least two emotional state indications to obtain an output emotional state indication.

30. The emotional recognition system of claim 29, wherein the post-processing function comprises an emotional state indication mapping function capable of being adapted to determine, for each of said at least two emotional state indications generated by the emotional state classifier, a corresponding set of emotional coordinates in said emotional state representation system.

31. The emotional recognition system of claim 30, wherein the emotional state indication mapping function is capable of being adapted to establish a univocal relationship between each emotional state indication and the corresponding set of emotional coordinates.

32. The emotional recognition system of claim 31, wherein the emotional state indication mapping function is further capable of being adapted to combine the sets of emotional coordinates corresponding to the at least two emotional state indications in the succession, in such a way as to determine a set of combined coordinates in an emotional state representation diagram, corresponding to a combined emotional state indication.

33. The emotional recognition system of claim 32, wherein the emotional state indication mapping function is further capable of being adapted to process the combined coordinates in such a way as to obtain a set of output coordinates, in said emotional state representation diagram, corresponding to the output emotional state indication.

34. The emotional recognition system of claim 33, wherein the output coordinates correspond to the emotional coordinates of the emotional state indication that is at a minimum distance from the combined emotional state in said emotional state representation system.

35. The emotional recognition system of claim 32, wherein said combined emotional state indication forms the output emotional state indication.

36. The emotional recognition system of claim 29, wherein the post-processing function further comprises a configuration function capable of being adapted to store configuration data, said configuration data comprising data defining the coordinates of the emotional state indications in said emotional representation system.

37. The emotional recognition system of claim 36, wherein the configuration data further comprises system parameters defining a number of emotional state indications in a succession of emotional states to be received by the post-processing function to produce the output emotional state indication.

38. The emotional recognition system of claim 37, further comprising an error analyzer capable of being adapted to provide an error indication indicative of a degree of inaccuracy of the output emotional state indication during a training phase, different from the operating phase in which an input information stream fed to the emotional state classifier is predetermined.

39. The emotional recognition system of claim 38, wherein the error analyzer is capable of being adapted to receive the succession of emotional state indications from the emotional state classifier, the output emotional state indication produced by the emotional post-processing function and a post-training classification table defining reference emotional state indications related to the predetermined input information stream, an error indication depending on the emotional state indications of the succession on the output emotional state indication and on the post-training classification table.

40. The emotional recognition system of claim 39, comprising parameters capable of being adapted to be set depending on the error indication provided by the error analyzer during the training phase.

41. The emotional recognition system of claim 39, further comprising an emotional filter function capable of being adapted to receive the error indication from the error analyzer during the training phase for varying data defining the coordinates of the emotional state indications in said emotional representation system in such a way as to change said coordinates depending on the error indication.

42. The emotional recognition system of claim 39, wherein the post-training classification table is capable of being adapted to be varied by a user of the emotional recognition system for changing the reference emotional state indications corresponding to the predetermined input information stream.

43. A method for the automated emotional recognition of emotional states of a person, comprising the steps of
during an operative phase:
receiving an input information stream with embedded information related to the emotional states of the person;
generating a succession of emotional state indications derived from said input information stream;
receiving at least two emotional state indications of said succession;
for each of said at least two emotional state indications, determining a corresponding emotional state representation in an emotional state representation system; and
combining the emotional state representations of said at least two emotional state indications to obtain an output emotional state indication.

44. The method of claim 43, further comprising the step of determining, for each emotional state indication of the succession, a corresponding set of emotional coordinates in said emotional representation system.

45. The method of claim 44, further comprising the step of establishing a univocal relationship between each emotional state indication and the corresponding set of emotional coordinates.

46. The method of claim 45, further comprising the step of combining the sets of emotional coordinates corresponding to at least two emotional state indications for determining a set of combined coordinates corresponding to a combined emotional state indication.

47. The method of claim 46, further comprising the step of processing the combined coordinates for obtaining a set of output coordinates corresponding to the output emotional state indication.

48. The method of claim 47, wherein the output coordinates correspond to the emotional coordinates of the emotional state indication that is at a minimum distance from the combined emotional state in said emotional state representation system.

49. The method of claim 46, wherein said output emotional state forms the combined emotional state.

50. The method of claim 43, wherein data defines coordinates of the emotional state indications in said emotional representation system.

51. The method of claim 50, wherein a number of emotional state indications in a succession of emotional states to be received to produce the output emotional state is defined by system parameters.

52. The method of claim 51, further comprising the steps of:
during a training phase, different from the operative phase:
providing a predetermined input information stream; and
generating an error indication indicative of a degree of inaccuracy of the output emotional state indication.

53. The method of claim 52, wherein the error indication depends on the emotional state indications of the succession, the output emotional state indication and a post-training classification table defining reference emotional state indications corresponding to the predetermined input information stream.

54. The method of claim 53, further comprising the step of:
during the training phase, setting the system parameters depending on an error indication provided by an error analyzer.

55. The method of claim 54, further comprising the step of:
during the training phase, using the error indication for varying the data defining the coordinates of the emotional state indications in said emotional representation system.

56. The method of claim 53, further comprising the step of:
during the training phase, varying the post-training classification table for changing the reference emotional state indications corresponding to the predetermined information stream.
